(19) United States
(12) Patent Application Publication
(10) Pub. No.: US 2009/0041988 A1
(43) Pub. Date: Feb. 12, 2009

(54) HOUSING FOR ELECTRONIC DEVICE AND METHOD FOR MAKING THE SAME

(75) Inventors: CHI-CHUANG HO, Tu-Cheng (TW); YUNG-TA LO, Tu-Cheng (TW); XIANG-ZHAO KONG, Shenzhen (CN); JING HAN, Shenzhen (CN); SONG LIU, Shenzhen (CN); FENG-YUEN DAI, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/952,138

(22) Filed: Dec. 7, 2007

(30) Foreign Application Priority Data
Aug. 7, 2007 (CN) 200710201293.X

(51) Int. Cl. B32B 3/30; B32B 15/04; C25D 11/02; C25D 11/04

(52) U.S. Cl. 428/172; 205/321; 205/322; 205/324; 205/333; 428/457

(57) ABSTRACT

An exemplary housing includes a light metal base and a ceramic film. The light metal base has an outer surface. The ceramic film is formed on the outer surface of the light metal base by micro-arc oxidation process. A method for making the present housing is also provided.

### BACKGROUND OF THE INVENTION

1. Field of the Invention

The present invention generally relates to housings for electronic devices, and particularly to a housing made of light metals, and a method for making the same.

2. Discussion of the Related Art

Light metals such as aluminium alloy, magnesium alloy, and titanium alloy, are good candidates for use in various portable electronic devices such as MP3 players, personal digital assistances (PDAs), and mobile phones because of their high mechanical strength and light weight.

When a housing of the electronic devices is made of light metal, the housing is easy to be corroded because the light metal reacts easily with other chemical substances such as acids. Typically, an anodic oxidation film is formed on an outer surface of the housing to protect the housing.

However, the anodic oxidation film has poor hardness. As a result, the anodic oxidation film is easy to be abraded or scratched. After the anodic oxidation film is abraded or scratched, the appearance of the housing may not be as pleasant as the original appearance.

What is needed, therefore, is a new housing that can overcome the above-mentioned shortcomings.

### SUMMARY

In one aspect, a housing for an electronic device includes a light metal base and a ceramic film. The light metal base has an outer surface. The ceramic film is formed on the outer surface of the light metal base by micro-arc oxidation process.

A method for making a housing includes: providing a light metal preform having an outer surface; processing the light metal preform with micro-arc oxidation method such that a ceramic film is formed on the outer surface of the light metal preform.

Other advantages and novel features will become more apparent from the following detailed description of various embodiments, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present housing. Moreover, in the drawings, like reference numerals designate corresponding parts throughout several views, and all the views are schematic.

FIG. 1 is an isometric view of a housing according to a first preferred embodiment of the present invention.

FIG. 2 is a side, cross-sectional view of the housing of FIG. 1, taken along line II-II.

FIG. 3 is a flow chart of making the housing shown in FIG. 1.

FIG. 4 is a sketch map of the micro-arc oxidation process shown in FIG. 3.

FIG. 5 an isometric view of a housing according to a second preferred embodiment of the present invention.

FIG. 6 is a side, cross-sectional view of the housing of FIG. 5, taken along line VI-VI.

FIG. 7 is a flow chart of making the housing shown in FIG. 5.

### DETAILED DESCRIPTION OF THE PREFERRED EMBODIMENTS

Reference will now be made to the drawings to describe preferred embodiments of the present housing for an electronic device, and method for making the same, in details. The housing can be a front cover, a back cover, a foldable cover or a slidable cover.

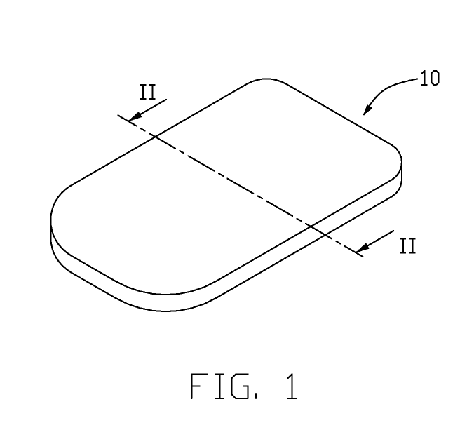

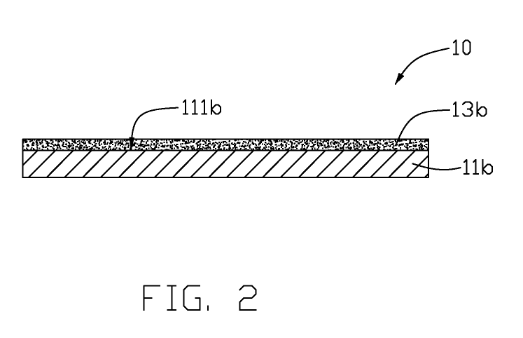

Referring to FIGS. 1 and 2, the housing 10 includes a light metal base 11b and a ceramic film 13b formed on an outer surface 111b of the light metal base 11b by micro-arc oxidation process.

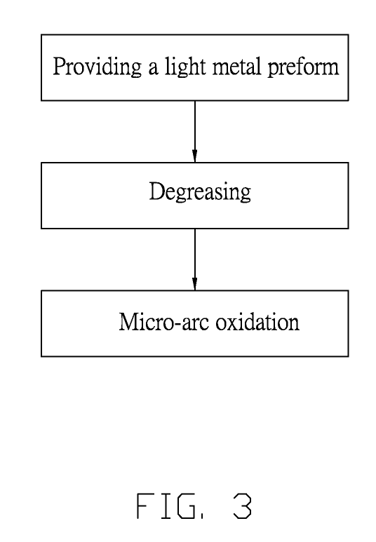

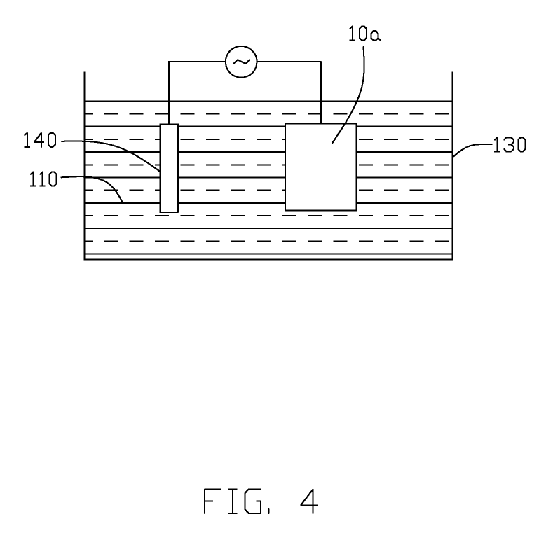

Referring to FIGS. 3 and 4 together, a method for making the housing 10 includes the following steps:

A light metal preform 10a is provided. The light metal preform 10a is made of aluminium alloy.

The light metal preform 10a is fixed on a frame (not shown), then the light metal preform 10a and the frame are immersed into an alkalescent solution 110 contained in a vat 130. The light metal preform 10a acts as an anode. A surface (not labeled) of the light metal preform 10a is to be oxidized. A rod 140 is immersed into the alkalescent solution 110 and acts as a cathode. In the illustrated embodiment, the alkalescent solution 110 is consisting of sodium metasilicate and water. A weight ratio of sodium metasilicate to water is in a range from 0.05% to 5%. In addition, potassium hydroxide can be added to the water to improve an anticorrosion ability of the ceramic film 13b. A weight ratio of potassium hydroxide to sodium metasilicate, in the alkalescent solution 110, is in a range from 5% to 50%.

An alternating pulse voltage is applied to the light metal preform 10a so that an alternating current passes through the surface of the light metal preform 10a and the rod 140. The positive going pulse is in a range from 300 volts to 800 volts. The negative going pulse is larger than 0 volts and smaller than 300 volts. A frequency of the alternating voltage is in a range from 25 HZ to 300 HZ. The positive going pulse and the negative going pulse are substantially rectangular in shape. A pulse width of the positive going pulse and the negative going pulse can be adjusted separately.

When the light metal preform 10a is immersed into the alkalescent solution 110, the surface of the light metal preform 10a is oxidized, thus an oxidation film is formed on the surface of the light metal preform 10a. Meanwhile, micro-arc discharges are generated on the surface of the light metal preform 10a because of the high voltage and high current. A temperature of the surface of the preform 10a can be several thousand degrees high and may even be in the ten thousand degree range due to the micro-arc discharge. The oxidation film is transformed into a ceramic film consisting of α-AL₂O₃ and β-AL₂O₃ due to the high temperature. In other words, a part of the light metal preform 10a is transformed into the ceramic film 13b shown in FIG. 2, another part of the light metal preform 10a remains unchanged and becomes the light metal base 11b shown in FIG. 2. The ceramic film 13b has a relative high insulation, for example, a breakdown voltage of the ceramic film 13b is 2000 volts.

In the above mentioned process, oxidation time is decreased by increasing the pulse width of the positive pulse, thus a speed of forming the ceramic film 13b is increased. When the negative pulse is applied to the light metal preform 10a, the negative pulse drives some hydroxide ion to penetrate into the ceramic film 13b, thus a density of the ceramic film is increased. Therefore, a good anticorrosion ability is achieved.

The ceramic film 13b has high hardness and anti-abrasion ability because the ceramic film 13b is consisting of α-AL₂O₃ and β-AL₂O₃. In the illustrated embodiment, a hardness of the ceramic film 13b can be in a range from about 700 HV to about 2500 HV. Comparing the hardness of the conventional anodic oxidation film in a range from about 300 HV to about 500 HV, the ceramic film 13b has a higher hardness. As a result, the ceramic film 13b has a high anti-abrasion ability, for example, an abrasion ratio of the ceramic film 13b can be 4.9×10⁻⁷ mm³/N²m.

It can be understood that, the light metal preform 10a can be made of other light metal such as one of titanium alloy, magnesium alloy, tantalum alloy, zirconium alloy. However, a performance of the ceramic film 13b will vary with the type of the material of the light metal preform 10a. For example, if the light metal preform 10a is made of magnesium alloy, a hardness of a ceramic film formed on the light metal preform 10a is in a range from about 350 HV to about 500 HV; if the light metal preform 10a is made of titanium alloy, a hardness of a ceramic film formed on the light metal preform 10a is in a range from about 400 HV to about 1000 HV.

It is noted that, in order to form the ceramic film easily, the light metal preform 10a can be treated with a degrease process before the micro-arc oxidation.

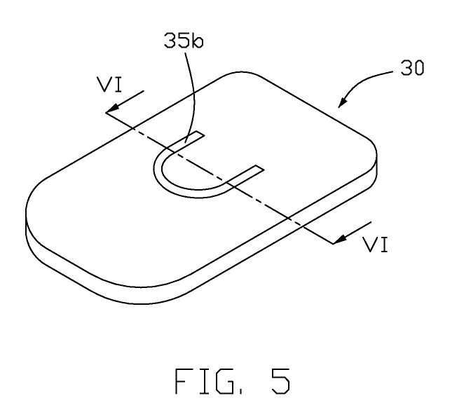

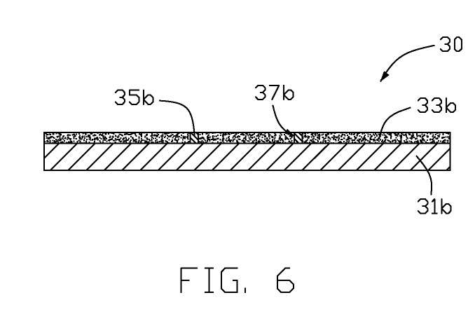

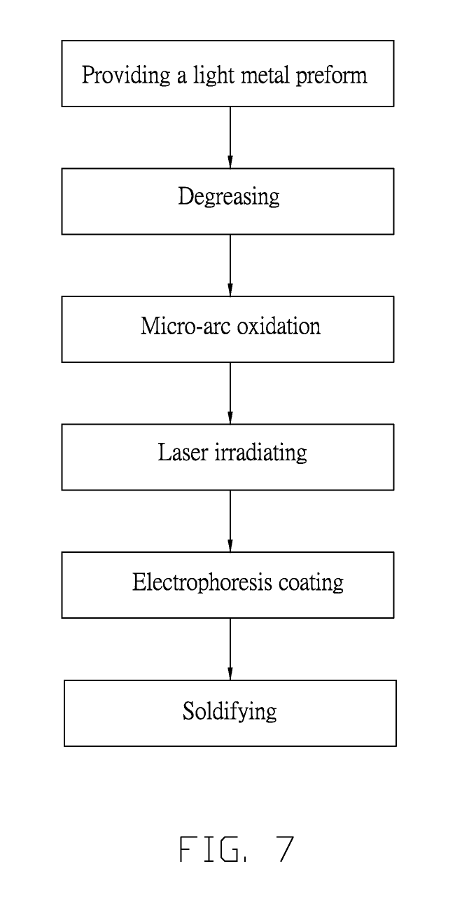

A housing 30 in accordance with a second preferred embodiment of the present invention is shown. Referring to FIGS. 5 and 6, the housing 30 includes a light metal base 31b and a ceramic film 33b formed on an outer surface of the light metal base 31b by micro-arc oxidation process. A depression pattern 37b is defined in the ceramic film 33b. Coating materials 35b is filled in the depression pattern 37b. As a result, the depression pattern 37b with the coating materials 35b forms a logo or mark. Referring to FIG. 7, a method for making the housing 30 includes the following steps:

A preform (not shown) is provided. The preform is made of light metal. In the illustrated embodiment, the light metal is aluminium alloy.

The preform is processed by micro-arc oxidation method such that a ceramic film is formed on an outer surface of the preform. That is, the preform becomes a configuration including a light metal base 31b and a ceramic film 33b formed on an outer surface of the light metal base 31b shown in FIG. 6.

A surface of the ceramic film 33b is process with radiation of laser. The part of the ceramic film 33b, that the laser beam touches, evaporates. Thus a depression pattern 37b is defined in the ceramic film 33b.

The preform is immersed in into an electrophoresis coating solution contained in a tank (not shown). The electrophoresis coating solution is consisting of a plurality of coating particles and water. The coating particles are negative. The preform acts as an anode. The tank acts as a cathode. When a positive potential is applied to the preform, the coating particles migrates to the preform and fills the depression pattern 37b of the ceramic film 33b to form a coating film. A method of forming the coating film includes spraying coating, printing, electrophoresis coating, and so on.

After the coating film is formed, the preform is taken out of the electrophoresis coating solution. Then the coating film is solidified and is transformed into coating materials 35b. Thus, the coating materials 35b with the depression pattern 37b form a logo or mark.

In the above mentioned process, all surfaces of the preform are insulated except a bottom surface of the depression pattern 37b is conductive. Therefore, the coating particles are only deposited on the bottom surface of the depression pattern 37b and fill the depression pattern 37b. The coating film is formed with a high accuracy. Consequently, the coating materials 35b are formed with a high accuracy.

When the coating materials 35b fills the depression pattern 37b, a thickness of the coating materials 35b is substantially equal to a depth of the depression pattern 37b. The depth of the depression pattern 37b is substantially equal to a thickness of the ceramic film 33b. Thus, the thickness of the coating materials 35b is substantially equal to the thickness of the ceramic film 33b. Moreover, an area of the coating materials 35b is smaller than that of the ceramic film 33b. The coating materials 35b are like blocks inserted into the ceramic film 33b. In use, the coating materials 33 is seldom touched, there is no abrasion problem exiting. As a result, the housing has relative high anti-abrasion ability.

In addition, the coating materials 35b is like a block inserted into the ceramic film 33b, in contrast to a coating materials formed on a surface of ceramic film 33b directly, the coating materials 35b has a higher adhesion. Thus, a pattern defined by the coating materials 35b has a higher reliability.

In the illustrated embodiment, the electrophoresis coating process is anodic electrophoresis coating process and the coating materials is epoxy resin. In an alternative embedment, the electrophoresis coating process can be cathode electrophoresis coating process. The coating materials can be selected from a group consisting of epoxy resin, polyurethane resin, acrylic resin, and any suitable combination thereof.

Finally, while various embodiments have been described and illustrated, the invention is not to be construed as being limited thereto. Various modifications can be made to the embodiments by those skilled in the art without departing from the true spirit and scope of the invention as defined by the appended claims.

What is claimed is:

1. A housing comprising:
a light metal base having an outer surface, and
a ceramic film formed on the outer surface of the light metal base by micro-arc oxidation process.

2. The housing as claimed in claim 1, wherein the housing defines at least one depression pattern in the ceramic film thereof, and the housing further comprises coating materials filling the at least one depression pattern.

3. The housing as claimed in claim 2, wherein the coating materials is selected from a group consisting of epoxy resin, polyurethane resin, acrylic resin, and any suitable combination thereof.

4. The housing as claimed in claim 1, wherein the light metal base is made of aluminium alloy, and the ceramic film is made of one of α-AL₂O₃ and β-AL₂O₃.

5. The housing as claimed in claim 4, wherein a hardness of the ceramic film is in a range from about 700 HV to about 2500 HV.

6. The housing as claimed in claim 1, wherein the light metal base is made of magnesium alloy, and a hardness of the ceramic film is in a range from about 350 HV to about 500 HV.

7. The housing as claimed in claim 1, wherein the light metal base is made of titanium alloy, and a hardness of the ceramic film is in a range from about 400 HV to about 1000 HV.

8. A method for making a housing, comprising:
providing a light metal preform having an outer surface;
processing the light metal preform with micro-arc oxidation method such that a ceramic film is formed on the outer surface of the light metal preform.

9. The method as claimed in claim 8, further comprising two steps after forming the ceramic film on the outer surface of the light metal preform: defining at least one depression pattern in the ceramic film with radiation of laser; and filling the at least one depression pattern with coating materials.

10. The method as claimed in claim 9, wherein the step of filling the at least one depression pattern with coating materials is processed by electrophoresis coating method.

11. The method as claimed in claim 9, wherein the coating materials is selected from a group consisting of epoxy resin, polyurethane resin, acrylic resin, and any suitable combination thereof.

12. The method as claimed in claim 8, wherein the light metal preform is made of aluminium alloy, and the ceramic film is made of one of α-AL₂O₃ and β-AL₂O₃.

13. The method as claimed in claim 12, wherein a hardness of the ceramic film is in a range from about 700 HV to about 2500 HV.

14. The method as claimed in claim 9, wherein the light metal base is made of magnesium alloy, and a hardness of the ceramic film is in a range from about 350 HV to about 500 HV.

15. The method as claimed in claim 9, wherein the light metal base is made of titanium alloy, and a hardness of the ceramic film is in a range from about 400 HV to about 1000 HV.

16. The method as claimed in claim 9, further comprising a degreasing step before forming the ceramic film on the outer surface of the light metal preform.
